(19) United States
(12) Patent Application Publication
(10) Pub. No.: US 2025/0050348 A1
(43) Pub. Date: Feb. 13, 2025

(54) COOLING MODULE

(71) Applicant: TECAN TRADING AG, Männedorf (CH)

(72) Inventors: Onur PEHLIVAN, Rapperswil (CH); Michael VAN DER STAAY, Männedorf (CH); Fred SCHINZEL

(21) Appl. No.: 18/723,657

(22) PCT Filed: Dec. 28, 2021
(86) PCT No.: PCT/EP2021/087739

§ 371 Date: Jun. 24, 2024

(51) Int. Cl. B01L 7/00

(52) U.S. Cl. CPC B01L 7/00; B01L 2200/147; B01L 2300/042; B01L 2300/1838; B01L 2300/1894

(57) ABSTRACT

A cooling module for receiving a plurality of containers has a housing that includes at least one opening, a cooling block arranged into the housing, at least one compartment for receiving the containers via the opening, and at least one cover for covering the opening against the exterior.

### TECHNICAL FIELD

The present invention relates to a cooling module and a liquid handling apparatus.

### PRIOR ART

Cooling modules are known for receiving a plurality of containers, e.g. vials, tubes, troughs, microplates, etc., filed with reagents, while being cooled to a specific temperature of e.g. 4-8° C. Such cooling modules can be exposed to laboratory conditions of e.g. 20-30° C. and humidity being up to 60%.

It is a problem in the state of the art that water condenses in cold structures of the cooling module, e.g. the cold walls of the containers. Said condensation is formed also at the (cold) inner walls of respective containers, resulting in entry of water to the reagents or rather in diluting the reagents. Hence, reactions using these reagents may fail or assays may deliver imprecise or false results.

### DESCRIPTION OF THE INVENTION

An object of the present invention is to provide a cooling module in which entry of water to reagents can be avoided. It is further object of the present invention to provide a liquid handling apparatus comprising such cooling module.

This object is solved by a cooling module having the features of claim 1, and a liquid handling apparatus according to claim 28. Further embodiments of the cooling module and liquid handling apparatus are defined by the features of further claims.

A cooling module according to the invention for receiving a plurality of containers comprises a housing including at least one opening, a cooling block arranged into the housing, at least one compartment for receiving the containers via the opening, and at least one cover for covering the opening against the exterior. In covering the openings, the temperature inside the cooling module is kept constant. Further, the interior of the cooling module is sealed against external moisture. Therefore, condensation of water at e.g. inner walls of the containers is eliminated or rather reduced significantly, thus avoiding addition of water to the reagents. In other words, dilution of the reagents is avoided.

In one embodiment, said cover is made of a thermal insulating material. In one embodiment, the opening is surrounded by a recess and the bottom of the cover is surrounded by a rim, wherein the contours of the recess and rim are formed such to substantially mate with each other. Hence, a labyrinth sealing is formed, providing enhanced seal and thermal isolation. Further, in case of vibrations or rather unintentional contact, movement or rather displacement of the covers can be reduced or rather prevented. In other words, the covers are supported more safely.

In one embodiment, the cooling module further comprises at least one carrier for receiving at least one of the containers, said carrier being adapted to be inserted into and/or removed from the compartment via the opening. Hence, the containers can be handled easily and in a more efficient way.

In one embodiment, the cooling block comprises at least one opening, wherein the at least one compartment is formed by said at least one opening.

In one embodiment, the cooling module further comprises at least two shells dimensioned such to sandwich at least the cooling block circumferentially. In one embodiment, the shells comprise a top shell and a bottom shell, wherein the top shell is formed with a rim, said rim being formed with a plurality of protrusions each protruding downwards in axial direction, and wherein said bottom shell comprises a plurality of recesses in a circumference thereof, adapted to engage the protrusions of the top shell, respectively. The protrusions and recesses can be formed wedge-shaped. The contours of the protrusions and recesses can be formed to mate each other. In doing so, the surface of the protrusion and the surface of the recess, each of the surfaces correspondingly formed, can engage each other, thus providing proper frictional locking. Hence, additional connection means can be omitted. Further, insulation is enhanced.

In one embodiment, the bottom shell, on a surface facing the interior of the cooling module, is formed with a recess pattern, substantially distributed across said surface, adapted to collect condensation water. In one embodiment, the recess pattern is provided with at least one outlet, adapted to drain condensation water collected in the recess pattern to the outside. Hence, by making use of gravity, moisture can be removed from the interior easily. The opening can comprise a hose connector to be connected with a hose in order to allow proper water discharge into a suitable container.

In one embodiment, the cooling block on a bottom side thereof is provided with a meandering recess, said cooling module further comprising a pipe inserted into said recess. In one embodiment, the pipe comprises an inlet and an outlet each provided with a bushing, wherein the pipe is adapted to circulate a coolant. The pipe can be arranged such that straight portions thereof run perpendicular to oblong slits or rather oblong compartments formed into the cooling block. Hence, cooling efficiency can be enhanced.

In one embodiment, the cooling module further comprises a heat conducting pad sandwiched at least partially between the meandering recess and the pipe, said heat conducting pad is made of a material comprising enhanced thermal conductivity. Hence, heat transfer from the cooling block to the surface of the pipe can be enhanced.

In one embodiment, the cooling module further comprises a temperature sensor, wherein a temperature measurement patch comprised by said temperature sensor is connected to said cooling block by means of a screw. In one embodiment, the temperature sensor is placed into a recess formed into the cooling block. The measurement patch is connected to the cooling block directly without any means interposed. The measurement patch and electronics comprised by the temperature sensor can be embedded in a single mold.

In one embodiment, the cooling module further comprises a controller electrically connected to the temperature sensor, said controller is adapted to control at least one of a chiller and pump in a closed loop control in response to temperature measurement values input to the controller from the temperature sensor.

In one embodiment, the cooling module further comprises at least one heating foil. In one embodiment, the heating foil is arranged in the housing, further arranged such to substantially surround the at least one opening of the housing. In one embodiment, the housing comprises a top surface covering the cooling module from above, wherein the heating foil is arranged in a recess inscribed into the top surface from below. The heating foil can be laced by thin leads heating the foil uniformly. The thus placed heating foil heats the top surface from underneath with the result of avoiding condensation at the surface of the top surface. Hence, condensing at a component, i.e. the top surface, highly exposed to condensing, is avoided. The heating foil is placed from the cooling block thus far away to avoid mutual interference.

In one embodiment the covers are stackable on top of each other. Said stacking of the covers saves space. Valuable space on the worktable of the liquid handling apparatus is thus saved. Further, the transfer path is reduced substantially, thus reducing working time as well as reducing potential collisions.

In one embodiment, the top of the cover is provided with an indentation and the bottom of the cover is provided with a protrusion, wherein contours of the indentation and protrusion are formed such to substantially mate with each other. In one embodiment, the bottom of the cover is provided with a rim, and wherein the top of the cover is provided with notches running in parallel in lengthwise direction of the cover, wherein contours of at least portions of the rim and contours of the notches are formed such to substantially mate with each other. In one embodiment, the cover, at lateral surfaces thereof facing each other in longitudinal direction of said cover, is formed with gripping portions. In one embodiment, the gripping portions each comprise a substantially plane surface. In one embodiment, the gripping portions are formed substantially in an upper portion of the cover. In one embodiment, the cover is made of a material comprising one of expanded polypropylene, polystyrene and foam material.

In one embodiment, the containers comprise at least one of vials, troughs, tubes, and microplates. In one embodiment, the cooling block is made of a material providing increased thermal conductivity, in particular aluminium.

The mentioned embodiments of the cooling module can be used in any combination provided they do not contradict one another.

A liquid handling apparatus comprise a pipetting apparatus and a cooling module according to one of the preceding embodiments. In one embodiment, the liquid handling apparatus further comprises a gripping device.

### BRIEF DESCRIPTION OF THE FIGURES

Exemplary embodiments of the present invention are explained in further detail hereinafter with references to the figures. These merely serve for explanation and should not be interpreted as restrictive. In the figures:

FIG. 1 shows a perspective view of a liquid handling apparatus comprising a pipetting system, a gripping apparatus and a cooling module in a first embodiment according to the invention;

FIG. 2 shows a perspective view of the cooling module with openings uncovered;

FIG. 3 shows a perspective view of the cooling module with openings all covered;

FIG. 4 shows a perspective view of the cooling module as shown in FIG. 3 with one opening uncovered;

FIG. 5 shows a perspective view of a carrier for receiving containers to be placed into the cooling module;

FIG. 6 shows, in an exploded view, components of the cooling module comprising a top shell, a cooling block and a pipe;

FIG. 7 shows, in an exploded view, components of the cooling module comprising the cooling block and a bottom shell;

FIG. 8 shows, in an exploded view, components of the cooling module comprising the top shell and the bottom shell;

FIG. 9 shows the cooling block in a perspective view;

FIG. 10 shows a perspective view of the cooling module in a bottom view;

FIG. 11 shows the cooling module in a sectional view in a vertical plane;

FIG. 12 shows a perspective view of a single cover in a top-down view;

FIG. 13 shows a perspective view of a single cover in a down-top view;

FIG. 14 shows a perspective view of two covers stacked about each other;

FIG. 15 shows the two stacked covers as shown in FIG. 14 in a sectional view in a vertical plane perpendicular to the lengthwise direction of said covers;

FIG. 16 shows the two stacked covers as shown in FIG. 14 in a sectional view in a vertical plane in lengthwise direction of said covers;

FIG. 17 shows a perspective view of a cooling module in a second embodiment in a top-down view; and

FIG. 18 shows a perspective view of components of the cooling module in the second embodiment in a down-top view.

### DETAILED DESCRIPTION OF THE INVENTION

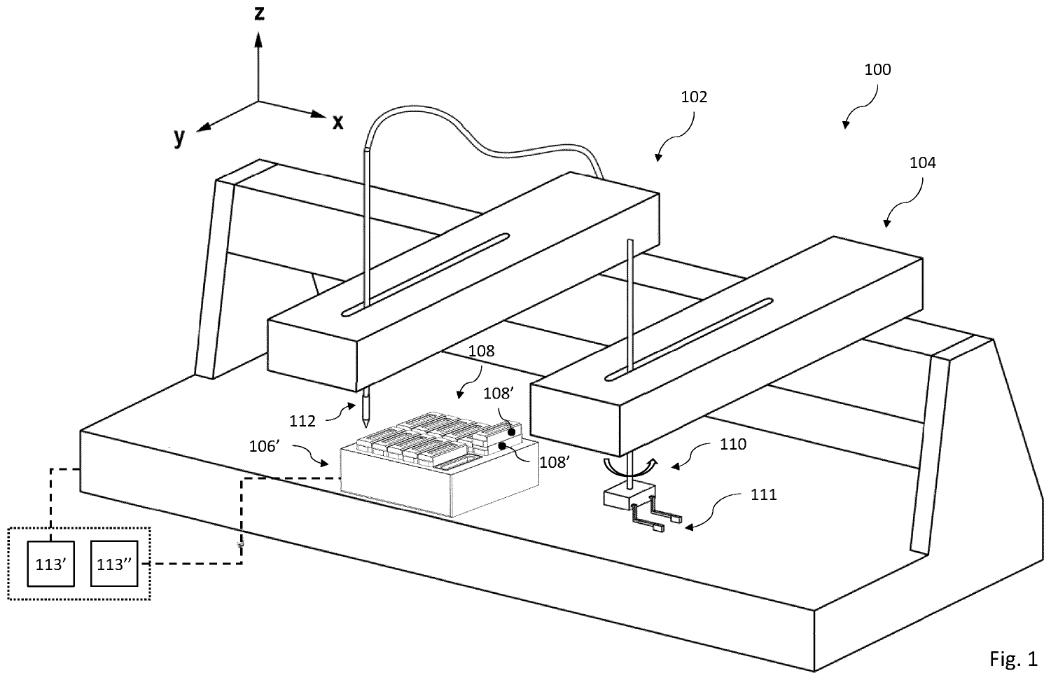

FIG. 1 shows a perspective view of a liquid handling apparatus 100 comprising a pipetting system 102, a gripping apparatus 104 and a cooling module 106′ in a first embodiment of the invention.

The cooling module 106′ is for reagents to be cooled filled in containers (not shown). A plurality of said containers can be received in carriers. Said carriers can be received into compartments of the cooling module 106′ via respective openings of the cooling module 106′ (to be described in the following in more detail).

In the shown configuration of the cooling module 106′, except of one opening, all openings are covered by a cover 108, respectively. The uncovered compartment of the cooling module 106′ can receive a carrier by means of a gripper 110 comprised by the gripping apparatus 104. Otherwise, a carrier can be taken from the compartment by the gripper 110 as well.

As mentioned above, the openings can be covered by a cover 108. The cover 108 can be made of a thermal insulating material, e.g. expanded polypropylene, polystyrene, foam material, etc. In covering the openings, the temperature inside the cooling module 106′ is kept constant. Further, the interior of the cooling module 106′ is sealed against external moisture. Advantageously, condensation of water at e.g. inner walls of the containers is eliminated or rather reduced significantly, thus avoiding addition of water to the reagents. In other words, dilution of the reagents is avoided.

Each cover 108 can be lifted, along a Z-axis, or rather taken from a respective opening by means of the gripper 110. Further, each opening can be covered by the cover 108 by means of the gripper 110, as well.

In an example, in order to place a carrier into a respective compartment which opening is covered by e.g. a cover 108′, the gripper 110, by means of fork-like gripping arms 111 thereof, can first laterally grip the respective cover 108′, lift said cover 108′ from the opening along the Z-axis, transfer said cover 108′ in a X-Y-plane, and place or rather stack said cover 108′ on top of an adjacent cover 108″. In stacking the covers, no additional space is required for placing the cover. Valuable space on the worktable of the liquid handling apparatus is thus saved. Further, the transfer path is reduced substantially, advantageously reducing working time as well as reducing potential collisions. Afterwards, the gripper 110 can move to the carrier, grip and take the carrier, move the carrier to the cooling module 106′, and place said carrier into the compartment. Afterwards, the gripper 110 can take the respective cover 108′ from the underlying cover 108″ and finally place the cover 108′ on the opening. Next to moving the gripper 110 up and down along the Z-axis and moving the gripper 110 along the X-Y-plane, the gripper 110 can also be rotated, as indicated by an arrow.

In another exemplary method, in the course of e.g. reagents handling or rather pipetting, the gripper 110 can lift-off the cover 108′ from an opening of a respective compartment comprising a container which is filled with a reagent to be pipetted by a pipette 112 comprised by the pipetting apparatus 102. Similar to the example as described above, the said cover 108′ can be stacked on top of the adjacent cover 108″. Afterwards, with the respective compartment being exposed to the above, pipetting can be initiated by the pipette 112. After pipetting, the respective cover 108′ can be placed back on the opening by means of the gripper 110, to thus seal the compartment or rather the interior of the cooling module 106′ against the exterior. The liquid handling apparatus 100 can comprise a first controller 113′ capable to mutually control or rather drive at least the pipetting system 102 and gripping apparatus 104. A further comprised second controller 113″ can be connected to the cooling module 106′. Said second controller 113″ can be able to control cooling of the cooling module 106′. In an example, the second controller 113″ can control or rather drive a chiller for removing heat from a coolant circulated inside the cooling module 106′ (to be described in the following). The same can relate to a pump for circulating the coolant. Said controlling can in turn be performed in cooperation with temperature measurement values received from a temperature sensor comprised by the cooling module 106′ (to be described in the following). The first controller 113′ and second controller 113″ can be designed as one single controller (indicated by a dotted box).

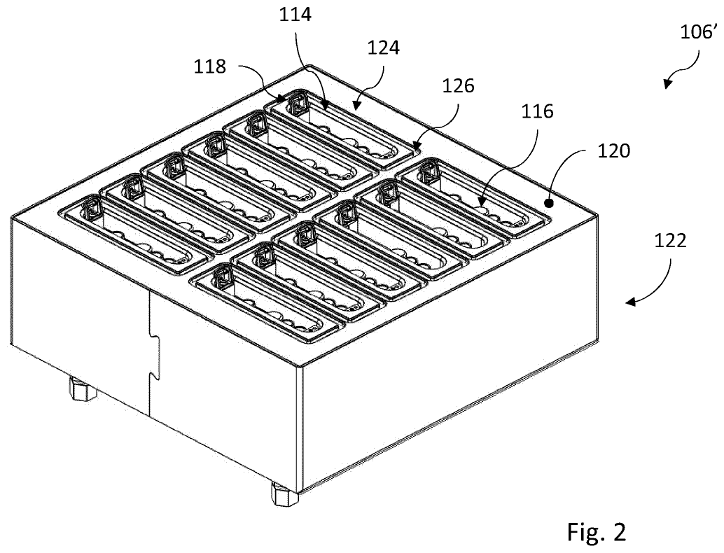

FIG. 2 shows a perspective view of the cooling module 106′. In the shown example, the cooling module 106′ comprises twelve compartments in two rows, wherein each row comprises six compartments, respectively. In the shown example, each compartment is occupied by a carrier 114, respectively. Each carrier 114 can in turn receive e.g. up to six containers 116, e.g. side by side. In the shown example, the compartments are not covered from above, allowing access from above to the carriers respectively to the containers 116 or rather to reagents filled into the containers 116. The containers 116 can be opened to the above, e.g. tubes, vials, etc., or can be sealed. While the cooling module 106′ is shown to comprise oblong compartments, each capable of receiving one oblong carrier 114, wherein the carrier 114 in turn can receive a plurality of containers 116, the compartments can be formed circular, each capable of receiving e.g. one tube without a carrier.

Each carrier 114, at opposing lateral sides in the lengthwise direction of each carrier 114, is provided with handles 118 protruding to the above (due to a better visibility, each carrier 114 is shown with just one handle 118). The handles 118 can be mounted to the carrier 114 by means of a screw connection. The handles 118 can be laterally engaged by means of gripping arms of an external gripping tool, e.g. the gripping arms 111 of the gripper 110 as shown in FIG. 1. In order to allow lateral engagement or rather grip, the handles 118 can extend to the above such to protrude from a top surface 120 of a housing 122 of the cooling module 106′. Thus, the handles 118 can be gripped laterally by the fork-like gripper arms 111 (refer to FIG. 1) in the course of removing or inserting the carrier 114 from or rather into the compartment.

Each of the compartments is shown opened to the above via an opening 124 formed into the top surface 120 of the housing 122. The openings 124 are surrounded by a recess 126, respectively. The contour of the recess 126 is formed such to substantially mate with a contour of a protrusion formed at the bottom of a cover (to be described in more detail in the following). In doing so, a labyrinth sealing is formed, providing enhanced sealing and thermal isolation. Further, in case of vibrations or rather an unintentional contact, movement or rather displacement of the covers is reduced or rather prevented. In other words, the covers are supported more safely.

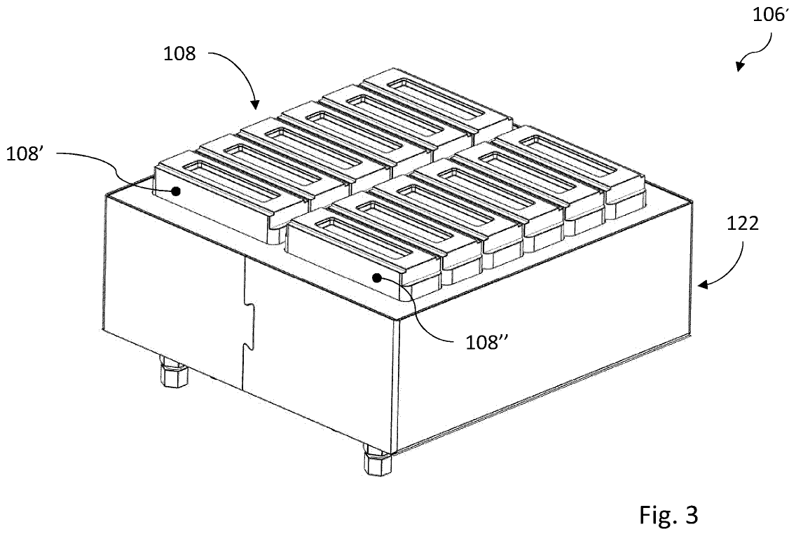

FIG. 3 shows the cooling module 106′ as shown in FIG. 2, with the distinction of that each opening is covered by the covers 108, respectively. As described above, the covers 108 seal the interior of the cooling module 106′ against the environment, thus allowing to keep the temperature inside the cooling module 106 more constant. Further, the interior of the cooling module 106′ is sealed against external moisture. Hence, condensation conditions inside the cooling module 106′ is reduced significantly, which could otherwise e.g. result in water condensing at inner walls of the received containers.

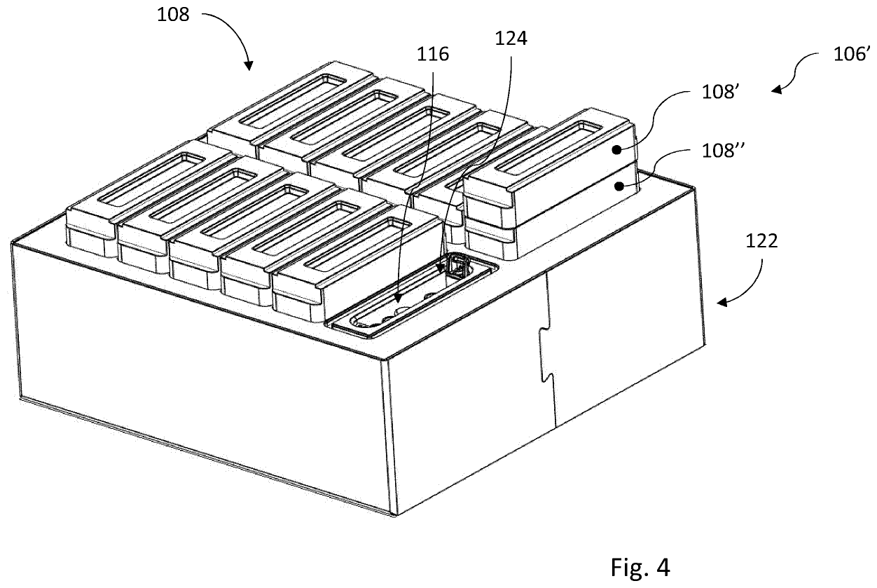

FIG. 4 shows the cooling module 106′ as shown in FIG. 3, with the distinction of that one of the compartments via its opening 124 is exposed to the above or rather not covered by the respective cover 108′. Said cover 108′ is shown lifted-off from the said opening 126 and placed or rather stacked on top of the adjacent cover 108″. Said stacking allows space saving. Further, the transfer path is limited substantially, which reduces working time and avoids potential collisions.

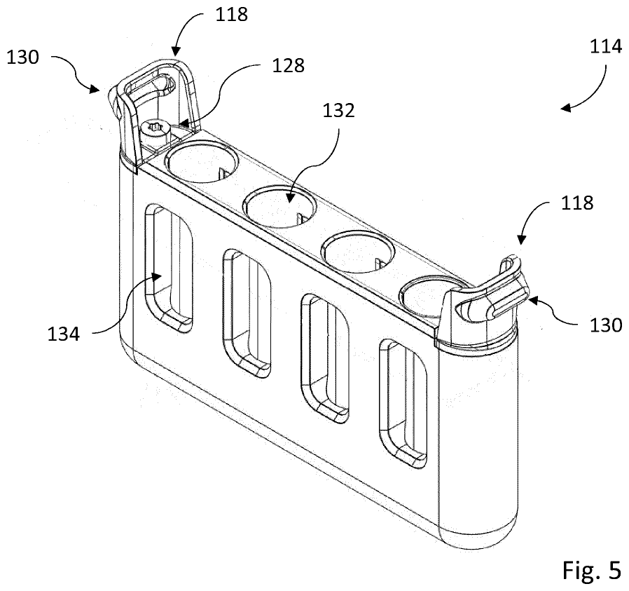

FIG. 5 shows a perspective view of the carrier 114 for receiving containers (not shown), which carrier 114 can be placed into one of the compartments of the cooling module (not shown). The carrier 114 can be formed of a material allowing enhanced thermal conductivity, e.g. metal, preferably aluminium. The handles 118 can be mounted to the body of the carrier 114 by means of a screw 128. The handles 118 protrude to the above in order to allow lateral grip by gripping arms of a gripper (not shown).

The handles 118 are each formed with bulges 130, each protruding laterally outwards in the lengthwise direction of the carrier 114. The bulges 130 can be oval, formed with a rounded contour. Gripping surfaces of gripping arms of a gripper, which gripping surfaces are respectively facing each other (not shown), can be formed with recesses which contours are formed rounded such to mate the contours of the bulges 130. In doing so, the carrier 114 can be gripped by is handles 118 more safely. Advantageously, slightly offsets can be compensated.

Further, the bottom of the carrier 114, along its entire circumference, can be formed rounded. In doing so, insertion of the carrier 114 into a compartment, e.g. the compartment of the cooling module (not shown), can be performed more safely. Also here, slightly offsets can be compensated.

The shown carrier 114 comprises four openings 132 adapted to receive a container (not shown) from the above. Lateral walls of the carrier 114 opposing each other in a vertical plane in lengthwise direction of the carrier 114 are formed with cut-outs 134, allowing visibility to a printing attached to a respectively received container. Said printing can be printed on a label, tag, etc., labeled on the respective container. The printing can e.g. comprise information about a content filled into the respective container, e.g. a batch code. The information can be captured automatically or manually, e.g. by means of an optical scanner (not shown). The printing can comprise a barcode, QR-code, 3D-code, etc.

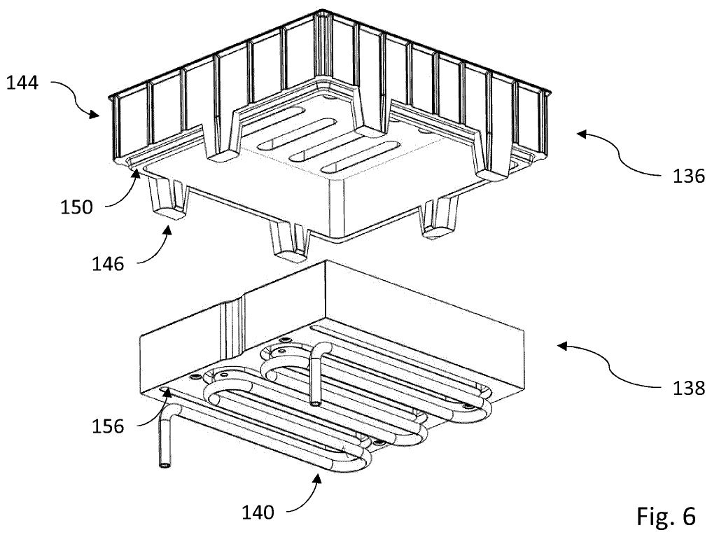

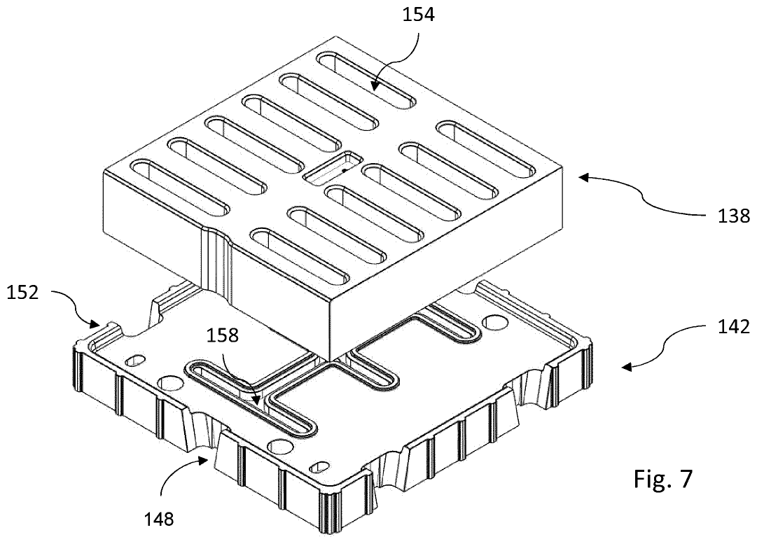

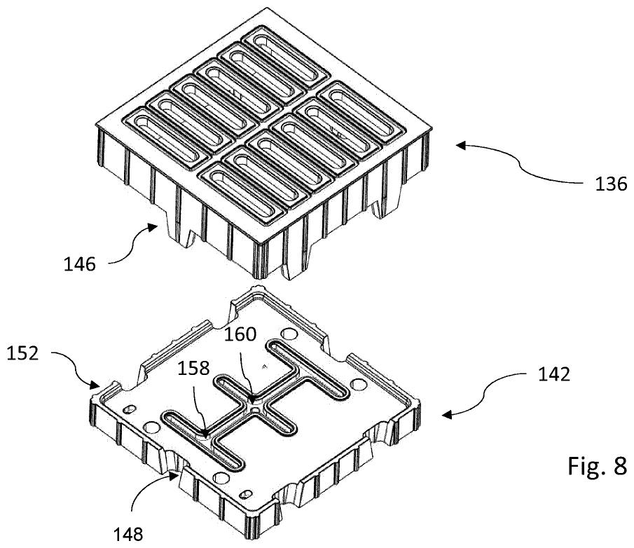

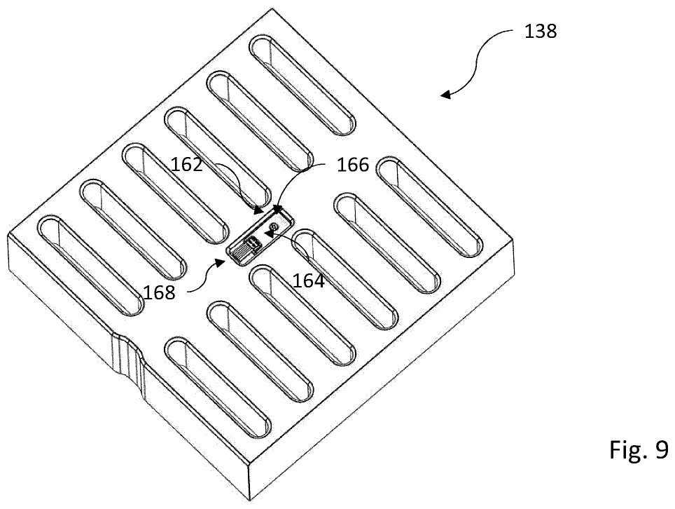

FIG. 6 shows, in an exploded view, components of the cooling module comprising a top shell 136, a cooling block 138 and a pipe 140; whereas FIG. 7 shows, in an exploded view, components of the cooling module comprising the cooling block 138 and a bottom shell 142; and whereas FIG. 8 shows the top shell 136 and bottom shell 142. FIG. 9 shows the cooling block 138 in an individual view.

The top shell 136 and bottom shell 142 are designed to sandwich at least the cooling block 138 circumferentially. Both shells 136, 142 are formed of a thermal insulating material, e.g. expanded polypropylene, polystyrene, foam material, etc., adapted to provide thermal insulation or to rather insulate the interior of the cooling module 106′ against the exterior.

The top shell 136 is formed with a circumferential rim 144. Said rim 144 is formed with a plurality of protrusions 146 (in the shown example six protrusions 146) each protruding from the rim 144 downwards in axial direction.

The bottom shell 142, in the circumference thereof, comprises a plurality of recesses 148, arranged and formed such to engage the protrusions 146 of the top shell 136, respectively. The protrusions 146 and recesses 148 can be formed wedge-shaped. The contours of the protrusions 146 and recesses 148 can be formed to mate each other. In doing so, the surface of the protrusion 146 and the surface of the recess 148, each of the surfaces correspondingly formed, can engage each other, thus providing proper frictional locking. Hence, additional connection means can be omitted. Further, insulation is enhanced.

The bottom of the rim 144 of the top shell 136 is formed with a circumferential first fringe 150, which outer contour matches with an inner contour of a circumferential second fringe 152 formed in the bottom shell 142. The outer contour of the first fringe 150 and the inner contour of the second fringe 152 can be formed wedge-shaped in order to e.g. ease assembling of the top shell 136 and bottom shell 142. Further, enhanced circumferential connection between the top shell 136 and bottom shell 142 is allowed, resulting in enhanced insulation.

The cooling block 138 is formed with oval slits opened to the above in axial direction. Said slits are forming the above mentioned compartments 154. The compartments 154 are arranged and dimensioned such to substantially correspond to the openings 124 formed into the top surface 120 of the housing 122 (refer to FIG. 2). The cooling block 138 is adapted to withdraw heat from containers placed directly (or supported by means of a carrier) into the compartments 154, in order to cool down said containers and thus the contained fluids. While the compartments 154 are depicted as oval slits, the compartments 154 can be formed circular, capable to e.g. receive a single tube, vial, etc.

The bottom of the cooling block 138 is provided with a recess 156 formed in meandering loops, adapted to receive the pipe 140, which is formed in meandering loops, too. The pipe 140 is adapted to circulate a coolant to withdraw heat from the cooling block 138, to thus cool down the cooling block 138. The meandering path allows an increased contact area between the outer surface of the pipe 140 and the recess 156 or rather body of the cooling block 138, to thus enhance cooling efficiency.

The bottom shell 142, on a surface facing the interior of the cooling module 106′, is formed with a recess pattern 158, substantially distributed across said surface. Said recess pattern 158 is adapted to collect condensation water which has been accumulated inside the cooling module 106′. The recess pattern 158 is provided with an outlet 160, adapted to drain condensation water collected in the recess pattern 158 downwards to the outside by making use of gravity. Hence, moisture can be removed from the interior.

FIG. 9 shows the cooling block 138 in an individual view. The cooling block 138 comprises a temperature sensor 162 adapted to measure the temperature of the cooling block 138. The temperature sensor 162 comprises a temperature measurement patch 164, which is connected to said cooling block 138 by means of a screw 166. Preferably, the temperature measurement patch 164 is connected to the cooling block 138 directly without any means interposed. The temperature measurement patch 164 and electronics comprised by the temperature sensor 162 can be embedded in a single mold. The temperature sensor 162 is placed into a recess formed into the cooling block 138. The temperature sensor 162 can output temperature measurement values via an electrical conductor 168, comprising e.g. a plurality of leads, to a non-shown controller. The controller can be comprised by the cooling module 106′ or can be configured externally. Said controller is in turn adapted to control the temperature of the cooling block 138 in a closed loop control in response to said temperature measurement values input to the controller from the temperature sensor 162. In doing so, the controller can control or rather drive a chiller and/or pump. Thus, a reliable and stable temperature setting of the cooling block 138 can be achieved.

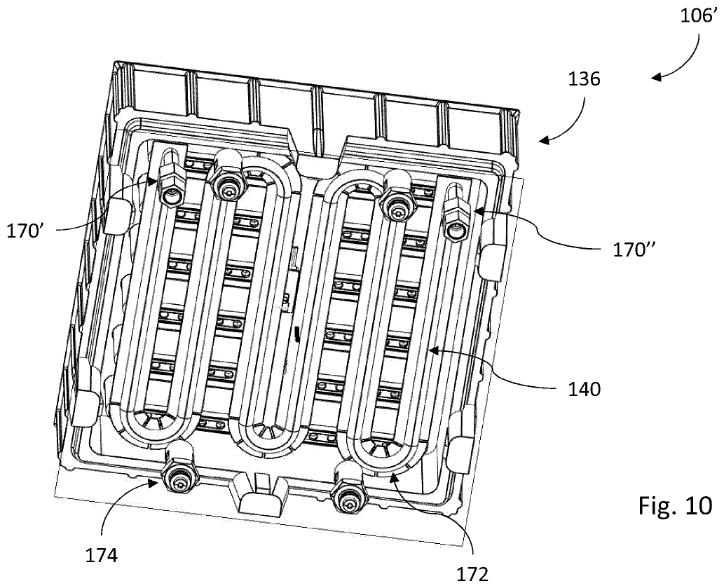

FIG. 10 shows a perspective view of the cooling module 106′ in a bottom view, with the bottom shell removed. Both ends of the pipe 140 can be provided with bushings 170′, 170″ in order to ensure proper inlet/outlet of the coolant via a non-shown circulating device, e.g. a pump and a chiller. The chiller is for removing heat from the coolant circulated inside the pipe 140. The pump is for circulating the coolant. At least one of the chiller and pump can be connected to the second controller 113″ as shown in Fig.1. The second controller 113″ can control or rather drive the chiller and/or pump in cooperation with the temperature measurement values received from the temperature sensor 162 as described in the foregoing FIG. 9.

A heat conducting pad 172 is sandwiched at least partially between the meandering recess (refer to FIG. 6) and the pipe 140. Said heat conducting pad 172 is formed of a strip made of a material comprising enhanced thermal conductivity. Hence, heat transfer from the cooling block 138 to the surface of the pipe 140 is enhanced. The heat conducting pad 172 can be pinched into the recess, wherein the strip is provided with respective cuts at each of the bends. The cooling module 106′ rests on four supports 174, which can penetrate through respective openings formed into the bottom shell (refer to FIGS. 7 and 8), screwed into respective threads formed into the bottom side of the cooling block 138 (refer to FIG. 6). The pipe 140 is arranged such that straight portions thereof run perpendicular to the oblong slits or rather compartments 154 formed into the cooling block 138. Hence, cooling efficiency can be enhanced.

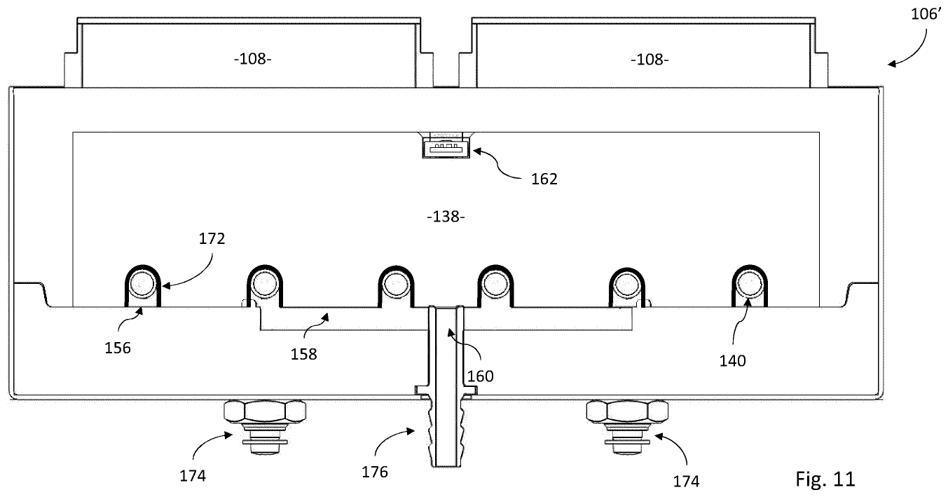

FIG. 11 shows the cooling module 106′ in a sectional view in a vertical plane. In the shown example, the heat conducting pad 172 surrounds the walls of the recess 156 while parts thereof are proper sandwiched between walls of the recess 156 and the outer surface of the pipe 140. This can be achieved by firstly pushing the conducting pad 172 into the recess 156. Afterwards, the pipe 140 is pressed into the thus prepared recess 156. Due to the ductility of the material of the pipe 140, the heat conducting pad 172 is snuggly pressed against the walls of the recess 156. Hence, heat transfer from the cooling block 138 to the outer surface of the pipe 140 is enhanced.

The opening 160 for draining condensing water from a portion of the recess pattern 158 downwards to the outside can comprise a hose connector 176 to be connected with a hose (not shown) in order to allow proper water discharge into e.g. a suitable container (not shown).

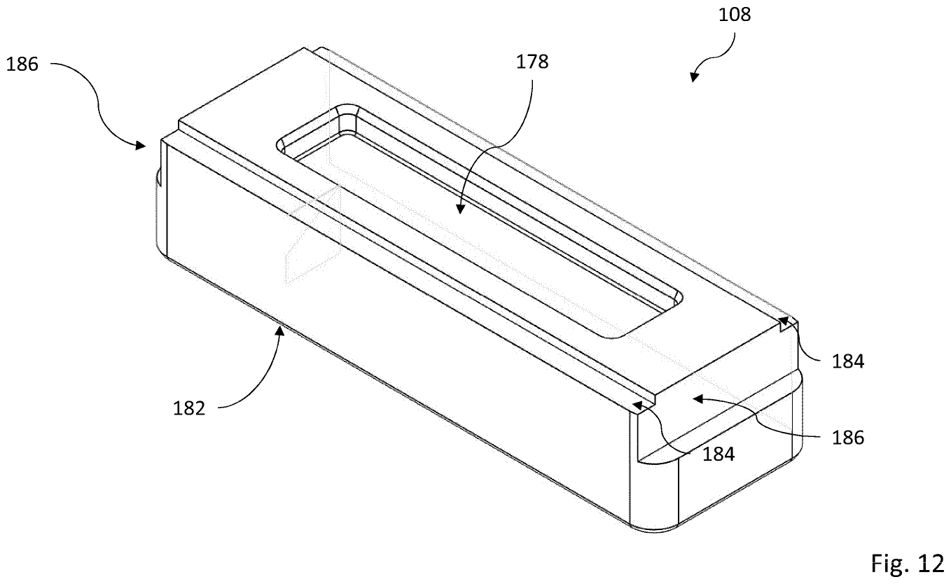

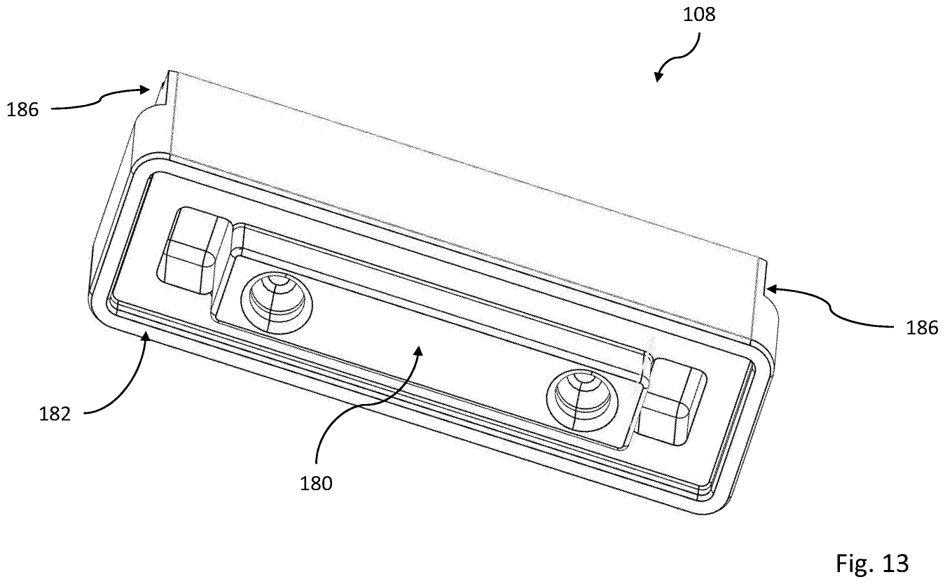

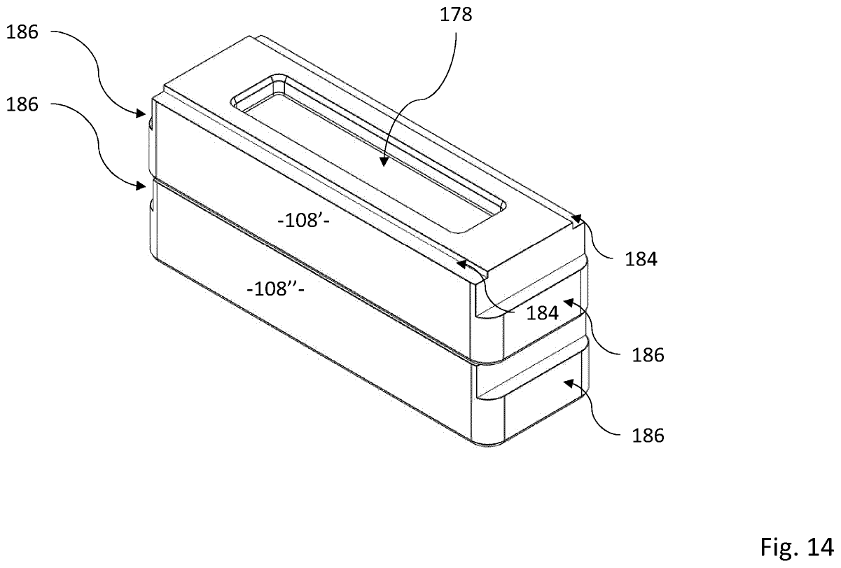

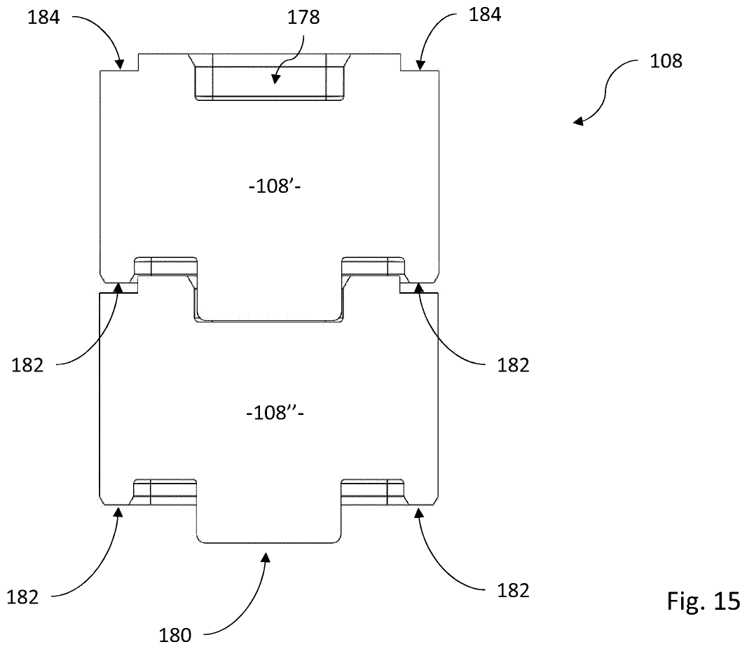

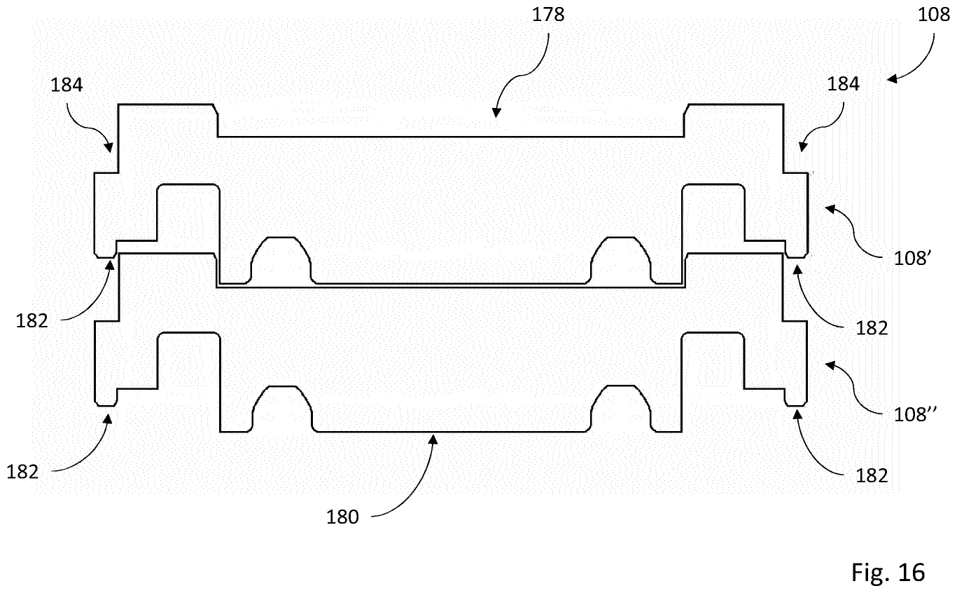

FIG. 12 shows a perspective view of a single cover 108 in a top-down view; whereas FIG. 13 shows a perspective view of the single cover 108 in a down-top view. FIG. 14 shows a perspective view of two stacked covers 108′, 108″; whereas FIG. 15 shows the two stacked covers 108′, 108″ in a sectional view in a vertical plane perpendicular to the lengthwise direction of said covers 108′, 108″; and whereas FIG. 16 shows the two stacked covers in a sectional view in a vertical plane in lengthwise direction of said covers.

The cover 108 can be made of a material comprising expanded polypropylene, polystyrene, foam material, etc. Hence, proper insulation can be achieved. The top of the cover 108 is formed with an indentation 178, whereas the bottom of the cover 108 is formed with a protrusion 180. The inner contour of the indentation 178 and the outer contour of the protrusion 180 are dimensioned such to substantially mate each other. Further, the bottom of the cover 108 can be provided with a circumferential rim 182, whereas the top of the cover 108 can be provided with notches 184 running in parallel in lengthwise direction of the cover 108. The inner contours of at least portions of the rim 182 running in parallel in lengthwise direction as well as the outer contours of the notches 184 are dimensioned such to substantially mate each other. The above mentioned provisions allow that the covers 108 can be properly stacked on top of each other. At the same time, the risk of a collapse of a stack of covers 108 can be prevented even in the event of vibrations or rather shock. Collapse of a stack of covers 108 can even be prevented or rather reduced even in the event of a collision with e.g. moving tools.

The contour of the circumferential rim 182 at the bottom of the cover 108 is dimensioned such to substantially mate with the contour of the recess 126 formed around each of the openings 124 in the top surface 120 (also refer to FIG. 2). Hence, the circumferential rim 182 also contributes to form the labyrinth sealing mentioned above in connection with FIG. 2, thus providing enhanced seal and thermal isolation.

Lateral surfaces of the cover 108, which surfaces are facing each other in a plane perpendicular to the longitudinal direction of said cover 108, are provided with gripping portions 186, each gripping portion 186 comprising a substantially plane surface. Said gripping portions 186 can be formed substantially in a top portion of the cover 108 to thus form a recess. Said plane gripping portions 186 allow proper grip or rather engagement, laterally, by means of gripping arms of a gripper (refer to FIG. 1).

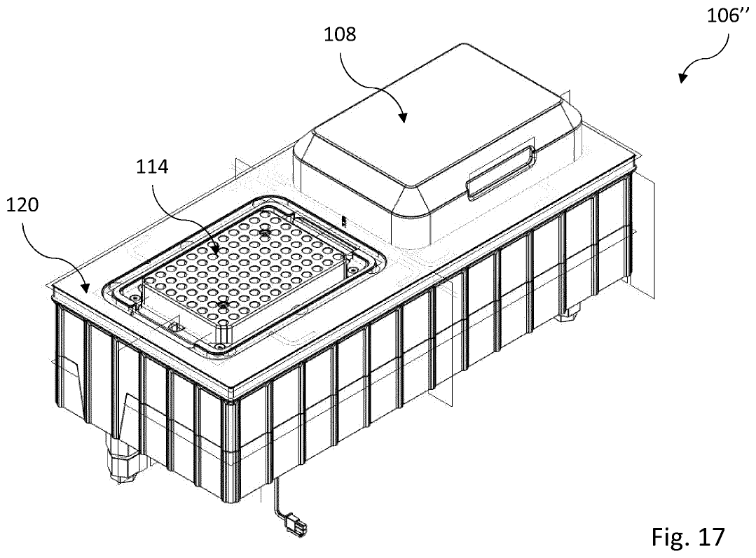

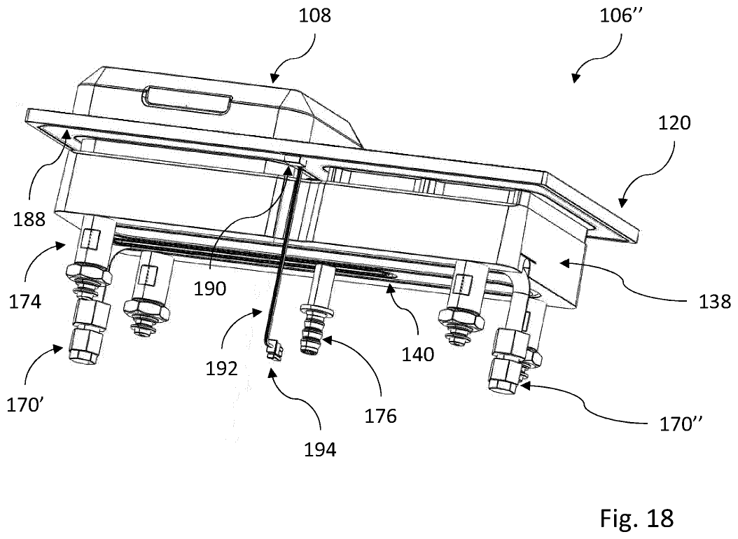

FIG. 17 shows a perspective view of a cooling module 106″ in a second embodiment in a top-down view, whereas FIG. 18 shows the cooling module 106″ in a down-top view with shells removed. The cooling module 106″ is shown in an embodiment capable of receiving two carriers 114 which can comprise e.g. microplates and multi-receptacles for receiving a plurality of containers comprising e.g. vials, tubes, troughs, etc. The carrier 114 can protrude from the top surface 120 to thus allow e.g. a microplate to be gripped and lifted laterally by means of a gripper.

The cooling module 106″ comprises a heating foil 188 placed at the bottom of the top surface 120. The heating foil 188 can be received in a recess inscribed into the bottom of the top surface 120. The heating foil 188 is arranged such to substantially surround the openings of the top surface 120 of the cooling module 106″. The heating foil 188 is supplied with energy via at least one contact 190, which is in turn connected to electrical leads 192 terminating in a plug 194. Said plug 194 can be connected to a non-shown controller, which can be arranged inside the cooling module 106″, adapted to control heating of the heating block 190. The heating foil 188 is laced by thin leads heating the foil uniformly. The thus placed heating foil 188 heats the top surface 120 from underneath with the result of avoiding condensation at the surface of the top surface 120. Hence, condensing at a component, i.e. the top surface 120, highly exposed to condensing, is avoided. The heating foil 188 is placed from the cooling block 138 thus far away to avoid mutual interference.

Lower portions of the containers or rather portions of the containers substantially occupied by liquid, are cooled by the cooling block 138 in a way as described above. The pipe 140 is received in a meandering recess formed into the bottom of the cooling block 138. Ends of the pipe 140 are provided with bushings 170′, 170″ in order to ensure proper inlet/outlet of coolant via a non-shown circulating device.

The cooling module 106″ can rest on supports 174, which can penetrate through respective openings formed into the bottom shell (not shown), screwed into respective threads formed into the bottom side of the cooling block 138.

Condensing water potentially collected inside the cooling module 106″ can be drained via the bottom opening 160 to the outside. The hose connector 176 allows proper connection with a hose for discharging the water into a suitable container (both not shown).

### REFERENCE SIGNS LIST

100 Liquid handling apparatus
102 Pipetting system
104 Gripping apparatus
106′, 106″ Cooling module
108, 108′, 108″ Cover
110 Gripper
111 Gripper arms
112 Pipette
113′ First controller
113″ Second controller
114 Carrier
116 Container
118 Handle
120 Top surface (of housing 122)
122 Housing
124 Opening
126 Recess
128 Screw
130 Bulge
132 Opening
134 Cut-out
136 Top shell
138 Cooling block
140 Pipe
142 Bottom shell
144 Rim
146 Protrusion
148 Recess
150 First fringe
152 Second fringe
154 Compartment
156 Meandering recess
158 Recess pattern
160 Outlet
162 Temperature sensor
164 Temperature measurement patch
166 Screw
168 Electrical conductor
170′, 170″ Bushing
172 Heat conducting pad
174 Support
176 Hose connector
178 Indentation
180 Protrusion
182 Rim
184 Notch
186 Gripping portion
188 Heating foil
190 Contact (of the wire to thin leads of the heating foil 188)
192 Electrical leads
194 Plug
X First horizontal axis
Y Second horizontal axis
Z Vertical axis

1. A cooling module (106′;106″) for receiving a plurality of containers (116), said cooling module (106′;106″) comprising:
a housing (122) including at least one opening (124),
a cooling block (138) arranged into the housing (122),
at least one compartment (154) for receiving the containers (116) via the opening (124), and
at least one cover (108, 108′, 108″) for covering the opening (124) against the exterior.

2. The cooling module (106′;106″) according to claim 1, wherein said cover (108, 108′, 108″) is made of a thermal insulating material.

3. The cooling module (106′; 106″) according to claim 1, wherein the opening (124) is surrounded by a recess (126) and the bottom of the cover (108, 108′, 108″) is surrounded by a rim (182), wherein the contours of the recess (126) and rim (182) are formed such to substantially mate with each other.

4. The cooling module (106′;106″) according to claim 1, further comprising at least one carrier (114) for receiving at least one of the containers (116), said carrier (114) being adapted to be inserted into and/or removed from the compartment (154) via the opening (124).

5. The cooling module (106′;106″) according to claim 4, wherein the cooling block (138) comprises at least one opening, wherein the at least one compartment (154) is formed by said at least one opening.

6. The cooling module (106′;106″) according to claim 1, further comprising at least two shells (136,142) dimensioned such to sandwich at least the cooling block (138) circumferentially.

7. The cooling module (106′;106″) according to claim 6, wherein the shells (136,142) comprise a top shell (136) and a bottom shell (142), wherein the top shell (136) is formed with a rim (144), said rim (144) being formed with a plurality of protrusions (146) each protruding downwards in axial direction, and wherein said bottom shell (142) comprises a plurality of recesses (148) in a circumference thereof, adapted to engage the protrusions (146) of the top shell (136), respectively.

8. The cooling module (106′; 106″) according to claim 6, wherein the bottom shell (142), on a surface facing the interior of the cooling module (106′;106″), is formed with a recess pattern (158), substantially distributed across said surface, adapted to collect condensation water.

9. The cooling module (106′;106″) according to claim 8, wherein the recess pattern (158) is provided with at least one outlet (160), adapted to drain condensation water collected in the recess pattern (158) to the outside.

10. The cooling module (106′;106″) according to claim 1, wherein the cooling block (138) on a bottom side thereof is provided with a meandering recess (156), said cooling module (106′;106′T) further comprising a pipe (140) inserted into said recess (156).

11. The cooling module (106′;106″) according to claim 10, wherein the pipe (140) comprises an inlet and an outlet each provided with a bushing (170′,170″), wherein the pipe (140) is adapted to circulate a coolant.

12. The cooling module (106′;106″) according to claim 10, further comprising a heat conducting pad (172) sandwiched at least partially between the meandering recess (156) and the pipe (140), said heat conducting pad (172) is made of a material comprising enhanced thermal conductivity.

13. The cooling module (106′; 106″) according to claim 1, further comprising a temperature sensor (162), wherein a temperature measurement patch (164) comprised by said temperature sensor (162) is connected to said cooling block (138) by means of a screw (166).

14. The cooling module (106′;106″) according to claim 13, wherein the temperature sensor (162) is placed into a recess formed into the cooling block (138).

15. The cooling module (106′; 106″) according to claim 13, further comprising a controller electrically connected to the temperature sensor (162), said controller is adapted to control at least one of a chiller and pump in a closed loop control in response to temperature measurement values input to the controller from the temperature sensor (162).

16. The cooling module (106′;106″) according to claim 1, further comprising at least one heating foil (188).

17. The cooling module (106′;106″) according to claim 16, wherein the heating foil (188) is arranged in the housing (122), further arranged such to substantially surround the at least one opening (124) of the housing (122).

18. The cooling module (106′;106″) according to claim 16, wherein the housing (122) comprises a top surface (120) covering the cooling module (106′;106′T) from above, wherein the heating foil (188) is arranged in a recess inscribed into the top surface (120) from below.

19. The cooling module (106′; 106″) according to claim 1, wherein the covers (108,108′,108″) are stackable on top of each other.

20. The cooling module (106′;106″) according to claim 1, wherein the top of the cover (108, 108′, 108″) is provided with an indentation (178) and the bottom of the cover is provided with a protrusion (180), wherein contours of the indentation (178) and protrusion (180) are formed such to substantially mate with each other.

21. The cooling module (106′;106″) according to claim 1, wherein the bottom of the cover (108,108′,108″) is provided with a rim (182), and wherein the top of the cover (108,108′,108″) is provided with notches (184) running in parallel in lengthwise direction of the cover (108,108′,108″), wherein contours of at least portions of the rim (182) and contours of the notches (184) are formed such to substantially mate with each other.

22. The cooling module (106′;106″) according to claim 1, wherein the cover (108,108′, 108″), at lateral surfaces thereof facing each other in longitudinal direction of said cover, is formed with gripping portions (186).

23. The cooling module (106′;106″) according to claim 22, wherein the gripping portions (186) each comprise a substantially plane surface.

24. The cooling module (106′;106″) according to claim 22, wherein the gripping portions (186) are formed substantially in an upper portion of the cover (108,108′,108″).

25. The cooling module (106′; 106″) according to claim 1, wherein the cover (108,108′,108″) is made of a material comprising one of expanded polypropylene, polystyrene and foam material.

26. The cooling module (106′;106″) according to claim 1, wherein the containers (116) comprise at least one of vials, troughs, tubes and microplates.

27. The cooling module (106′;106″) according to claim 1, wherein the cooling block (138) is made of a material providing increased thermal conductivity.

28. A liquid handling apparatus (100) comprising a pipetting apparatus (102) and a cooling module (106′;106″) according to claim 1.

29. The liquid handling apparatus (100) according to claim 28, further comprising a gripping device (104).
